(19) United States
(12) Patent Application Publication
(10) Pub. No.: US 2010/0044546 A1
(43) Pub. Date: Feb. 25, 2010

(54) APPARATUS SUPPORT STRUCTURE

(75) Inventor: Paul George Harris, Haverhill (GB)

Correspondence Address: SUGHRUE MION, PLLC, 2100 PENNSYLVANIA AVENUE, N.W., SUITE 800, WASHINGTON, DC, 20037, US

(73) Assignee: VISTEC LITHOGRAPHY INC., Watervliet, NY (US)

(21) Appl. No.: 12/522,868

(22) PCT Filed: Jan. 8, 2008
(86) PCT No.: PCT/GB08/00046

§ 371 Date: Jul. 10, 2009

(30) Foreign Application Priority Data
Jan. 10, 2007 (GB) 0700464.1

(51) Int. Cl. F16M 13/00; B29C 41/20

(52) U.S. Cl. 248/636; 264/277

(57) ABSTRACT

An apparatus support structure (11) with a damping characteristic comprises a rigid steel frame resistant to loading in bending and tension, a cladding (16) encapsulating the frame, and an apparatus mounting ring (21). The cladding is formed by a solidified composite casting material which is based on particulate mineral or metallic material, for example, granite, and a synthetic binder, for example epoxy resin, and which has a compliance permitting damping of movement transmitted between the structure and apparatus mounted on the ring (21). The structure can be produced by encasing the frame and ring in a mould constructed in situ around the frame and filing the mould with the cladding material in fluid state.

The present invention relates to an apparatus support structure, especially a structure suitable for supporting sensitive machines, tools and instruments, and to a method of producing such a support structure.

Support structures for apparatus take many forms and usually are adapted to the requirements and characteristics of the individual apparatus, for example weight, size, robustness, sensitivity to vibration and other factors. Special demands are imposed on support structures by machines, tools and instruments which are sensitive to vibration, yet have to be securely and rigidly supported. Use is commonly made of support structures of metal, which exhibit the necessary strength, but are susceptible to transmission of vibration and to resonance problems. Incorporation of damping elements leads to additional cost and complication as well as greater susceptibility to undamped resonances and compromised stiffness.

Sensitive apparatus are frequently mounted on tables or beds of natural granite, which offer a high degree of stiffness, but have obvious penalties with respect to weight and difficulty in shaping to accommodate or mount the apparatus and any associated subsystems. Granite composites may be capable of moulding to suitable shapes, but have poor tensile strength and thus present design problems if the material is used for structures intended to support heavy apparatus. Reinforced concrete, although common in the construction industry, is not usually employed for supporting apparatus such as sensitive machine and is again a heavy material.

It is therefore an object of the present invention to optimise, or at least improve the balance between, stiffness and damping in an apparatus support structure, particularly a structure suitable for apparatus sensitive to vibrations and other mechanically induced disturbances.

A further object of the invention is provision of method by which rational construction of a support structure fulfilling such a purpose may be undertaken.

A subsidiary object of the invention is attainment of enhanced flexibility in such a support structure by way of a construction in which fixing and mounting points satisfying specific requirements of different apparatus can be incorporated with relatively little change in design and without departing from a standard production procedure.

According to a first aspect of the present invention there is provided an apparatus support structure with a damping characteristic, comprising a rigid frame of metallic material resistant to loading in bending and tension, a cladding encapsulating at least a major part of the frame, and an apparatus mount, the cladding being formed by a solidified composite casting material which is based on particulate mineral or metallic material and a synthetic binder and which has a compliance permitting damping of movement transmitted between the structure and apparatus mounted on the mount.

A support structure of such a kind incorporates a frame designed and constructed to provide the stiffness required by, for example, vibration-sensitive equipment, especially strength in compression and tension, but with a cladding of a material selected to damp movement, such as vibration, emanating from apparatus supported by the structure or from subsystems carried by the structure. The tasks of stiffness on the one hand and damping on the other hand are thus apportioned to two different component parts and component materials respectively optimised for the tasks. Formation of the cladding from solidified composite casting material based on a particulate mineral or metallic material, for example granite, and a synthetic binder, for example epoxy resin, additionally allows moulding of the cladding not only to encase the frame to the extent necessary or substantially wholly if appropriate, but also moulding to accommodate shapes, components or subsystems of the apparatus concerned. A support structure with these capabilities has proved particularly suitable for equipment such as electron beam lithography tools, where there is a need for a support structure which is noise-free in terms of mechanical vibrations. The structure helps provide a quiescent system during writing by the beam and thus to reduce writing errors. The damping capability is particularly advantageous in reducing resonance settle periods following component movement and thus, in the context of the mentioned lithography tool, increasing working throughput by the tool. Mouldable granite composite by itself, while providing satisfactory damping and compressive strength, has poor tensile strength and has a propensity to failure when loaded in direct tension and bending. A support structure having a construction in accordance with the first aspect of the invention takes advantage of this compressive strength and damping capability, but without the risk of fracture when subjected to static and dynamic loads.

The structure preferably comprises attachment points externally accessible at the cladding for attachment of apparatus components or accessories. Such attachment points can include pins, threaded studs, drillings, sockets, threaded holes or any other item or formation suitable for mounting purposes. The number, kind and positioning of such attachment points can be varied relatively easily during construction of the frame and/or formation of the cladding, so as to allow adaptability to different types of apparatus or different variants in a series of apparatus. The attachment points can be formed at the frame and embedded in the cladding or simply embedded in the cladding, depending on, for example, the loads to be borne by individual points.

In a preferred embodiment, the frame and cladding include a box-like body portion, such a box shape representing a simple form which combines rigidity without excessive weight. The box-like body portion then represents the basic part of the structure and can, with advantage, define a cavity for reception of apparatus components or auxiliary elements. Thus, the apparatus or a principal part of the apparatus can be mounted on the mount and additional elements, such as subsystems, can be accommodated largely or wholly in the cavity, i.e. below the apparatus. The frame and the cladding can also be structured to define projections for engagement by support means, for example support posts or columns, for supporting the structure on a support surface such as a floor. The projections can be extensions of a table which is present at the top of the support structure to provide a support and/or work surface associated with the mounting and operation of the apparatus.

The frame can be constructed, at least in part, from suitable profile section members, at least some of which can be of H-section. H-section girders represent structural elements with a particularly high level of stiffness and have re-entrant zones or channels able to be filled with the cladding material to strengthen the union of the frame and cladding. However, the profile section members can equally well consist of or include box-section, I-section, Z-section, U-section and other appropriate sectional shapes.

The mount can have various forms depending on the nature of the apparatus to be mounted thereon and in one embodiment has the form of a ring of, for example, metallic material. The mount can be bonded to the cladding material, whereby it is kept in position in the structure, and at the same time spaced from the frame by that material. Additional anchorage of the mount can be achieved if the mount has openings or recesses filled with the cladding material.

According to a second aspect of the invention there is provided a method of producing a structure according to the first aspect of the invention, comprising the steps of providing a frame, disposing an apparatus mount in a predetermined position relative to the frame, encasing at least a major part of the frame and mount in a mould with walls thereof spaced from the frame and filling the mould with a solidifiable casting material based on particulate mineral or metallic material and a synthetic binder to form a cladding encapsulating a major part of the frame and mount.

Such a method provides a particularly rational means of constructing the support structure, in which an intimate bond of frame and cladding and enclosure of the former by the latter render the two parts permanently inseparable. The spacing of the mould walls from the frame determines the thickness of the cladding and thus to a significant extent the level of compliance of the finished structure. Accordingly, depending on the degree of damping required for the apparatus intended to be supported by the structure the mould walls can be positioned to provide a corresponding thickness of the cladding, the positioning being variable in different regions of the frame, if so desired, in order to provide different damping characteristics in different parts of the structure.

The mould for preference substantially wholly encases the frame so that the cladding will, in turn, encapsulate substantially the whole of the frame. The cladding material can, as already mentioned, comprise a mixture of particulate granite material and epoxy resin as binder, the mixture being introduced in a fluid state into the mould so as to flow entirely around the frame and mount and fill any openings or recesses—which are intended to be filled—in the frame and/or mount.

The mould preferably includes a base plate on which the frame is supported by means of spacers. In that case, so that the plate can define a smooth and flat top surface of the finished support structure the frame can be placed on the base plate in an orientation inverted relative to an intended orientation in use. It is, of course, possible to provide the base plate, at the side on which the frame is supported, with a profile, protrusion or other means for forming a complementary shaping in the solidified casting material between the plate and the frame, i.e. in the gap formed by way of the spacers. The spacers themselves can conveniently be constructed to serve as component attachment points, for example threaded inserts, in the finished structure.

Advantageously, the mount is placed directly on the base plate, with the result that a face of the mount will be exposed at the side of the finished support structure defined by the plate. The mount is preferably placed on the base plate at a spacing from the frame so that the casting material can penetrate between the mount and the frame and form a vibration-damping zone between these components.

The consistency of the casting material can be selected so that it flows, under gravitational force alone, around the frame to completely fill the mould. However, since the combination of particulate material and epoxy resin may be comparatively viscous it can be advantageous to assist the flow, such as by placing the base plate on a vibratory bed and vibrating the bed during the filling step. The vibration transmitted to the flowing mass of casting material ensures that the material does not prematurely settle in interior regions of the mould, in particular on parts of the frame, without continuing to flow into underlying unfilled regions. In that case the step of vibrating can comprise adjusting the vibration to remain constant as the mass of casting material increases during the filling step, so that the vibration is continuously adapted to the progressively increasing weight of material within the mould.

Although the mould can be a unitary structure, encasing of the frame by the mould is simplified if the mould is assembled from wall elements encasing individual parts of the frame. In effect, the mould can be constructed in situ around the frame, which simplifies adaptation to any comparatively complicated or re-entrant shapes of the frame. The mould can also include a core element locatable in a box-like body portion of the frame to form an internal cavity in the cladding. The cavity can serve to accommodate components of or subsystems for the apparatus, as well as ensuring lightness of the structure without compromising the rigidity of the finished structure.

The anchorage of the mount in the finished structure can be enhanced if the mount includes openings or recesses intended to receive the casting material and if the step of filling includes filling the openings or recesses with the casting material. A particularly strong interconnection of mount and cladding is thereby achieved.

A further aspect of the invention is represented by equipment comprising a support structure according to the first aspect of the invention, or produced by a method according to the second aspect of the invention, and apparatus mounted on the mount. The equipment can be, for example, an electron beam lithography machine and the apparatus an electron beam column of the equipment. The support structure can thus provide a stand or plinth capable of bearing the weight of the electron beam column and other components of the machine, for example a vacuum chamber casing containing a movable stage, and of damping to a substantial degree the vibration emanating from the stage and other parts of the equipment, particularly to assist with suppressing transmission of movement to sensitive parts of the column.

An embodiment of the present invention will now be more particularly described by way of example with reference to the accompanying drawings, in which:

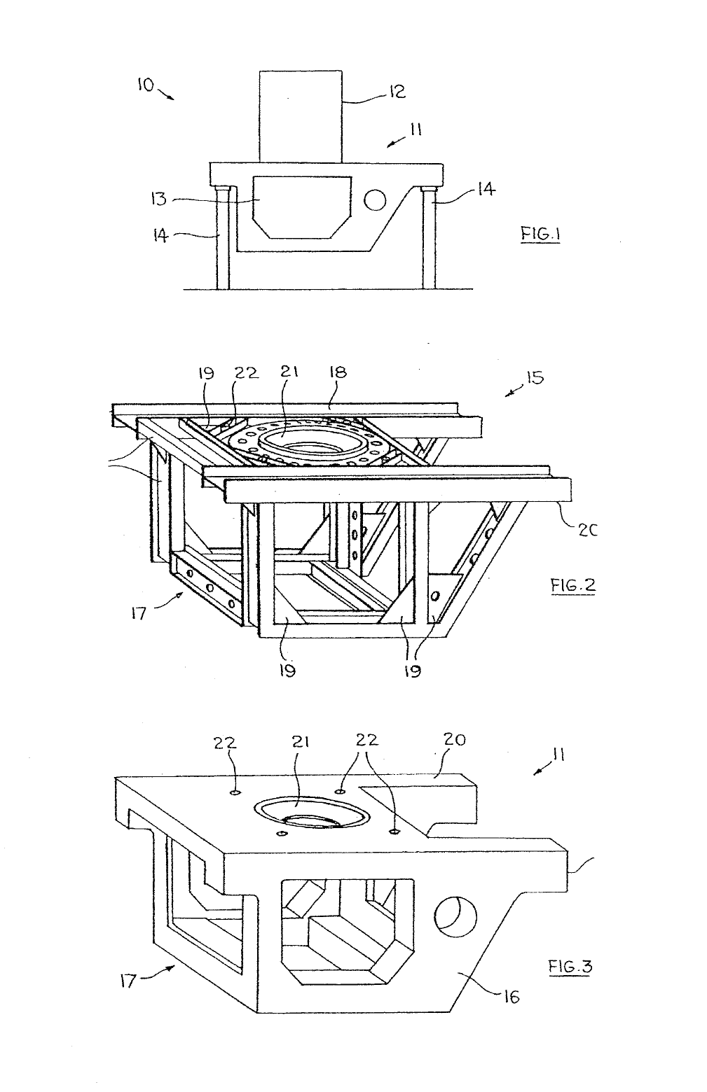

FIG. 1 is a schematic side elevation of equipment incorporating an apparatus support structure embodying the invention, showing apparatus supported on the structure;

FIG. 2 is a schematic perspective view of an internal frame and a mounting ring—by themselves—of the support structure shown in FIG. 1, to an enlarged scale;

FIG. 3 is a view corresponding with FIG. 2, but the complete support structure;

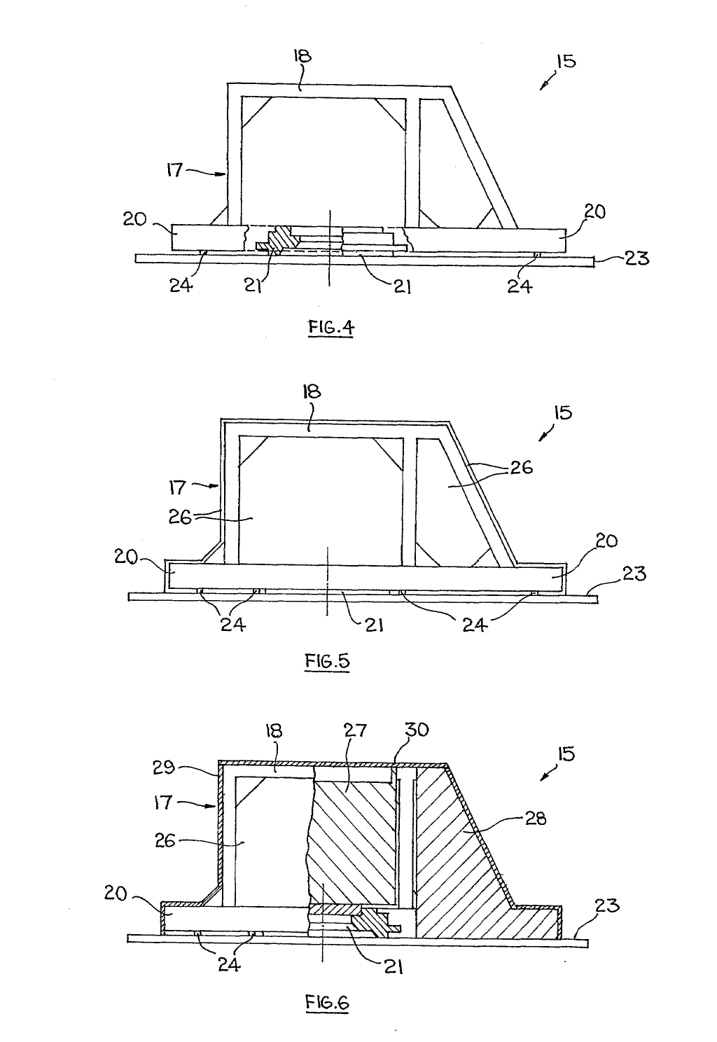

FIG. 4 is a partly broken-away schematic elevation showing an early phase of production of the support structure of FIG. 3, the structure being inverted relative to the illustration in FIGS. 1 to 3;

FIG. 5 is a view similar to that of FIG. 4, but showing an intermediate phase of the production; and

FIG. 6 is a partly broken-away and sectioned view similar to that of FIG. 5, but showing a late phase of the production.

Referring now to the drawings there is schematically illustrated in FIG. 1 equipment 10 incorporating an apparatus support structure 11 embodying the invention. The equipment in this instance is, by way of convenient example, an electron beam lithography machine. Apparatus in the form of an electron beam column 12 is supported on the support structure 11 and subsystems, including a vacuum chamber casing 13 containing an X-Y stage for movably carrying a substrate on which pattern writing is to be carried out by an electron beam generated by the column 12, are located in an interior cavity of the structure 11. The structure 11 is supported relative to the ground by vibration/shock insulating posts 14. The support structure 11 not only has to bear substantial loads represented by the weight of the column 12, casing 13 and other systems, but also has to resist any tendency to crack, fracture, deflect or deform (including expansion and contraction) and suppress transmission, or at least damp, vibration and other movements emanating from individual components of the equipment. Electron beam lithography machines operate to particularly close tolerances, often in the nanometre range, and even the slightest departure from a completely quiescent state can lead to operating inaccuracies, notably errors in writing. Consequently, the column should ideally be supported by a support structure combining the requisite rigidity with a damping characteristic.

This is achieved, in the case of the described embodiment, by construction of the support structure 11 from a frame 15 of metallic material, especially steel, as shown in FIG. 2, encapsulated in a cladding 16 formed by a solidified composite casting material, preferably granite particles of several grades incorporated in an epoxy resin binder, as shown in FIG. 3. The frame 15 comprises a rigid box-like body 17 bounding a cavity for reception of the casing 13 (FIG. 1) and formed by H-section, I-section and U-section rails 18 welded together and braced where appropriate by steel plate gussets 19, including an apertured gusset plate partly closing the intended upper side of the body 17. Top rails of the body 17 are extended in opposite directions to define projecting arms 20 which ultimately accept the supporting load relative to the posts 14 shown in FIG. 1, two of the arms with greater projecting length being additionally braced to the body by diagonal stays. The box-like body 17 composed of profiled elements with gusset bracing results in a particular rigid construction resistant to loading in bending, tension and compression and able to accept the weight of the column 12, casing 13 and other components of the equipment substantially without risk of deformation or deflection. The encapsulating cladding 16, on the other hand, imparts the desired damping characteristic which can be, for example approximately 40 times that of bare structural steel. The stiffness of the composite formed by the frame 15 and cladding 16 is such that a first vibration mode in the region of 100 Hertz for the described and illustrated embodiment is achievable. Connection of the cladding material with the frame 15 is particularly enhanced by penetration of the material into the channels of the rails 18 as well as into any holes that may be optionally provided in the rails 18 and gussets 19.

The support structure 11 further comprises a mounting ring 21 of metallic material, preferably steel, on which apparatus—in this instance the column 12—can be mounted. For this purpose, the ring 21 is arranged with a face thereof exposed at the top of the structure 11, thus not covered by the cladding 16. The ring 21 is preferably disposed at a spacing from the frame 15, in particular from the apertured gusset plate at the upper side of the box-like body 17, so that the composite of particulate granite and resin binder forming the cladding material not only extends around and bonds with the circumference of the ring, but also penetrates between the ring and the frame and bonds with the underside of the ring. In addition, the ring 21 can be provided with openings and/or recesses into which the cladding material penetrates to enhance the anchorage of the ring in the cladding.

The structure 11 can also incorporate component attachment points accessible at various surfaces of the cladding, for example threaded openings in sockets into which screw fasteners can be screwed. Several such attachment points 22 are shown, by way of arbitrary example only, on the top surface of the cladding 16 in FIG. 3. These attachment parts can also fulfill a function in manufacture of the structure 11, as described further below.

Different stages in production of the support structure 11 are illustrated in FIGS. 4 to 6.

Initially, the frame 15 is fabricated from the welded-together steel rails 18 and gussets 19 and the mounting ring 21 produced in integral form by casting and machining or simply by machining. The rails, gussets and ring are additionally provided with cut-outs, drillings and/or recesses for attachment locations or for reception of the cladding material, as may be required in accordance with the specific design and intended use of the finished support structure. The configuration and size of the frame and ring are, of course, similarly dictated in part by the intended use.

Subsequently, as indicated in FIG. 4, construction of a mould for encapsulation of the frame 15 and ring 21 to the extent required in each case is commenced by placing a base plate 23 on a support surface and placing the ring 21—inverted in relation to its orientation in the finished support structure—directly on the plate. The surface of the base plate 23 will define the top surface of the finished support structure and the face of the ring 21 resting on the plate will accordingly be exposed at that top surface. The frame 15, similarly inverted, is then supported on the base plate 23 by way of spacers 24 with the ring 21 correctly positioned relative to the frame, in particular adjacent to, but at a spacing from, the apertured gusset plate partly closing the intended upper side of the box-like body 17. The spacers 24 primarily serve to allow cladding material to flow under the inverted frame so as to cover the frame at its intended top side and thus define the top surface of the finished support structure, but secondarily can serve as attachment points at that top surface. For this purpose the spacers 24 can, for example, be formed with threaded bores.

In a further phase of mould construction, illustrated in FIG. 5, side walls 26 (only one of which is shown) are supported on the base plate 23 at a suitable spacing from the sides of the frame 15 so as to confine the flow of the encapsulating cladding material laterally of the frame. As shown in FIG. 5, the side wall 26 has a profile generally corresponding with the profile of the frame in side elevation, but of enlarged dimensions to define an outlying perimetral zone representing, in the finished support structure, the local thickness of the cladding. This thickness can thus be determined by the dimensions of the side walls and of further co-operating mould parts mentioned below and can be substantially uniform around the structure or varied if desired for enhanced damping characteristics in movement-sensitive areas.

A final stage of mould construction is schematically depicted in FIG. 6, in which a centre core element 27 is located within the box-like body 17 to allow formation of the cavity intended to receive the vacuum chamber casing 13, an end core element 28 is located between the longer arms 20 to form a space between those arms, the element 28 having lateral extensions to close off the rails of the frame 15 on the righthand side in FIG. 6, and an appropriately shaped end wall 29 is positioned adjacent to the frame to similarly close off the rails on the lefthand side in FIG. 6. Finally, a cover wall 30 is located above the inverted frame at a spacing therefrom to close off the top—later the base—of the frame. The cover wall 30 can be supported on the mould elements 26 to 29 and/or on spacers (not shown) disposed on the frame and optionally serving to provide attachment points at the underside of the finished structure.

The base plate 23 and other mould components 26 to 30 are indicated in highly schematic form; in practice these components can be assembled from individual parts of suitable shape adapted to accommodate the various shapes of the frame and gussets. In addition, other core elements will be required in different positions where filling by cladding material is not required, for example the interior of the ring 21.

Finally, the cladding material in a fluid state is introduced into the mould via one or more inlet openings and allowed to flow throughout the mould interior so as to fully encapsulate the frame 15 and ring 21 apart from that area or those areas, such as the face of the ring resting on the base plate 23, to be kept free of the material. The material is composed of several grades of granite particles mixed in a two-part epoxy resin carrier and the viscosity should be just sufficient to allow complete penetration of the mould interior. Flow can, however, be assisted by controlled vibration of the mould together with the included frame and mounting ring, for example by placing the base plate 23 on a vibratory bed so that vibration of the base plate can be transmitted to the fluid cladding material. In that case it is advantageous to adjust the vibration mode to maintain a constant value as the inflowing mass of material increases. The material also flows into the channels of the rails 18 and other openings and recesses in the frame 15 and ring 21 so that an intimate mechanical coupling between the cladding and these components is provided in addition to the surface bonding.

Although a mix of particulate granite and epoxy resin is preferred for the cladding material, other composite materials meeting the appropriate criteria, in particular mouldable, non-brittle materials which in hardened state are sufficiently compliant to provide the desired damping characteristic, are possible, for example a polymer dispersion with an incorporated particulate metallic or mineral component.

When the poured cladding material, after complete filling of the mould cavity, has hardened the mould-defining elements are removed. Removal may be facilitated by coating those mould surfaces which contact the cladding material with a suitable release agent. The finished support structure 11 produced by this process is then inverted and fitted, when required, with the parts of the equipment 10, including, for example, pneumatic pads on the undersides of the arms 20 for bearing on the support posts 14. Other such fittings can be provided at the frame prior to or after encapsulation with the cladding material, depending on requirements.

1-29. (canceled)

30. An apparatus support structure with a damping characteristic, comprising a rigid frame of metallic material resistant to loading in bending and tension, a cladding encapsulating at least a major part of the frame, and an apparatus mount, the cladding being formed by a solidified composite casting material which is based on particulate mineral or metallic material and a synthetic binder and which has a compliance permitting damping of movement transmitted between the structure and apparatus mounted on the mount.

31. A structure as claimed in claim 30, wherein the particulate mineral material is granite and the binder is epoxy resin.

32. A structure as claimed in claim 30, wherein the frame is substantially wholly encapsulated by the cladding.

33. A structure as claimed in claim 30, comprising attachment points externally accessible at the cladding for attachment of apparatus components or auxiliary components.

34. A structure as claimed in claim 30, wherein the frame and cladding include a box-like body portion.

35. A structure as claimed in claim 34, wherein the body portion defines a cavity for reception of apparatus components or auxiliary components.

36. A structure as claimed in claim 30, wherein the frame and cladding define projections for engagement by support means for supporting the structure on a support surface.

37. A structure as claimed in claim 30, wherein the mount is a ring.

38. A structure as claimed in claim 30, wherein the mount is bonded to and spaced from the frame by the cladding material.

39. A structure as claimed in claim 30, wherein the mount has openings or recesses filled with the cladding material to provide additional anchorage of the mount.

40. A method of producing a structure as claimed in claim 30, comprising the steps of providing a frame, disposing an apparatus mount in a predetermined position relative to the frame, encasing at least a major part of the frame and mount in a mould with walls thereof spaced from the frame and filling the mould with a solidifiable casting material based on particulate mineral or metallic material and a synthetic binder to form a cladding encapsulating a major part of the frame and mount.

41. A method as claimed in claim 40, wherein the mould substantially wholly encases the frame so that the cladding encapsulates substantially the whole of the frame.

42. A method as claimed in claim 40, wherein the particulate mineral or metallic material is granite and the binder is epoxy resin.

43. A method as claimed in claim 40, wherein the mould includes a base plate and the frame is supported on the base plate by means of spacers.

44. A method as claimed in claim 40, wherein the spacers are constructed and arranged to serve as component attachment points in the finished structure.

45. A method as claimed in claim 40, wherein the mount is placed directly on the base plate.

46. A method as claimed in claim 40, comprising the step of placing the base plate on a vibratory bed and vibrating the bed during the filling step.

47. A method as claimed in claim 46, wherein the step of vibrating comprises adjusting the vibration mode to remain constant as the mass of casting material increases during the filling step.

48. A method as claimed in claim 40, wherein the mould is assembled from wall elements encasing individual parts of the frame.

49. A method as claimed in claim 40, wherein the mould includes a core element locatable in a box-like body portion of the frame to form an internal cavity in the cladding.

50. A method as claimed in claim 40, wherein the mount includes openings or recesses intended to receive the casting material and the step of filling includes filling the openings or recesses with the casting material.

51. Equipment comprising a support structure as claimed in claim 30 and apparatus mounted on the mount.

52. Equipment as claimed in claim 51, the equipment being an electron beam lithography machine and the apparatus comprising an electron beam column.
